(19) United States
(12) Patent Application Publication
(10) Pub. No.: US 2018/0352785 A1
(43) Pub. Date: Dec. 13, 2018

(54) Environmentally Friendly House Cat scratcher with Simple Folding and Assembling

(71) Applicant: Petsweet Co., Ltd., Taipei City (TW)

(72) Inventor: Hsiang-Ting Chia, Taipei City (TW)

(21) Appl. No.: 15/871,471

(22) Filed: Jan. 15, 2018

(30) Foreign Application Priority Data
Jun. 12, 2017 (TW) 106208481

(51) Int. Cl. A01K 15/02

(52) U.S. Cl. CPC A01K 15/024

(57) ABSTRACT

An environmentally friendly house cat scratcher with simple folding and assembling mainly comprises a first cat scratching board and a second cat scratching board. The first and second cat scratching boards have a first and second shell and a first and second clawing portion. The first and second shells have troughs. The first and second clawing portions have the clawing surface structure produced by die cutting after paper compression. Holes are provided on the clawing surface structures for clawing by house cats, and the first and second clawing portion are assembled in troughs of the first and second shell. A first junction is configured between the first shell and the second shell, and the first cat scratching board is rotated corresponding to the second cat scratching board via the first junction, enabling the first shell and the second cat scratching boards to be folded or unfolded.

### TECHNICAL FIELD

The present invention relates to an environmentally friendly house cat scratcher with simple folding and assembling, and more particularly, to a cat scratcher structure which is easy to carrying, folding, and recycling. Moreover, various assemblies can be provided to increase the willing of house cats to scratch.

### BACKGROUND

Pets tend to claw for scraping the aged cuticle in their claws. Therefore, furniture and clothes in home are scratched by pet and get damaged. To avoid these damages, pet lovers, for example, feeding cat as a pet, usually use cat scratcher to provide pet a safe and comfortable environment for clawing.

A conventional cat scratcher structure, for example, a cat scratcher structure with spatial flow mark, mainly produced by cardboard piling and die cutting. Some disadvantages are listed below:
1. As a product for selling, the size of conventional cat scratcher is quite large so that the cat scratcher may not easily shift, and cat may not loss its interest when scratching. However, the large structures of cat scratchers occupy most space in superstores, and it is not easy to carry and increases more transportation expense.
2. Scraps of paper and old nails are produced when house cat do clawing on cat scratcher. The large scratcher, that leads to inconvenience to clean the environment. Moreover, when we recycle the overused cat scratcher, it will easily cause the paper and old nails scattering on the ground which makes it much harder to recycle them.
3. It is too simple without different clawing ways in conventional cat scratcher, that house cats may loss interest in clawing on the conventional cat scratcher.

### SUMMARY OF THE INVENTION

In this invention, an environmentally friendly house cat scratcher with simple folding and assembling is proposed. Based on this structure, cat scratchers can be assembled in several shells which can be folded or unfolded. In addition, it is convenient to carry and store in superstores.

To achieve the purpose, the structure of cat scratcher mainly includes a first cat scratching board and a second cat scratching board.

The first cat scratching board has a first shell and a first clawing portion. The first shell has a trough and the first clawing portion has the clawing surface structure produced by die cutting after paper compression. Holes are provided on the clawing surface structures for clawing by house cats, and the first clawing portion is assembled in the trough of the first shell.

The second cat scratching board has a second shell and a second clawing portion. The second shell has a trough and the second clawing portion has the clawing surface structure produced by die cutting after paper compression. Holes are provided on the clawing surface structures for clawing by house cats, and the second clawing portion is assembled in the trough of the second shell.

A first junction is configured between the first shell and the second shell, and the first cat scratching board is rotated corresponding to the second cat scratching board via the first junction, enabling said first and second cat scratching boards to be folded or unfolded.

In some embodiments, the first clawing portion and the first shell are combined through adhesives or twin adhesives; the second clawing portion is connected to the trough of second shell via adhesives or twin adhesives.

In some embodiments, a third cat scratching board is connected to the second cat scratching board. The third cat scratching board has a third shell and a third clawing portion. The third shell has a trough and the third clawing portion has the clawing surface structures produced by die cutting after paper compression. Holes are provided on the clawing surface structures for clawing by house cats. The third clawing portion is assembled in the trough of said third shell, a second junction is configured between the second shell and the third shell, and the third cat scratching board is rotated via said second junction, enabling the first, second, and third cat scratching boards to be folded or unfolded. The third clawing portion of third cat scratching board is connected to the trough of third shell via adhesives or twin adhesives.

In some embodiments, the house cat scratcher can be flatways extended to provide cat clawing in the invention. Furthermore, the first cat scratching board has a first combination area configured at two ends of the first junction, and the second cat scratching board has a second combination area configured at two ends of the first junction. A plurality of first supporting boards are assembled in two sides of the first combination area and the second combination area, and the first supporting boards are triangle boards to keep the first cat scratching board perpendicular to the second cat scratching board. The sticking cases such as adhesives or twin adhesives on the side wall of the first supporting board are separately attached to the side wall of the first combination area and the side wall of the second combination area to keep the first cat scratching board perpendicular to the second cat scratching board.

In some embodiments, the first, second, and third cat scratching boards can be flatways put on the ground to provide cat clawing in the invention. Furthermore, some examples can be embodied as follows. The first cat scratching board has a first combination area configured at two ends of the first junction, and the second cat scratching board has a second combination area configured at two ends of the first junction. A plurality of first supporting boards are assembled in two sides of the first combination area and the second combination area, and the plurality of first supporting boards are triangle boards to keep the first cat scratching board perpendicular to the second cat scratching board. The second cat scratching board has a third combination area configured at two ends of the second junction, and the third cat scratching board has a fourth combination area configured at two sides of the second junction. A plurality of second supporting boards is assembled in two sides of the third combination area and the fourth combination area. The second supporting boards are rectangle boards to extend the second cat scratching board and keep the second cat scratching board and the third cat scratching board in an upright position. House cats are likely to stand high above, so this embodiment can be used to attract house cats' attention. As a result, when house cats play and scratch on this scratcher, the scratcher prevents them from damaging furniture and clothes. Slots are separately configured in the third combination area and the fourth combination area, and a plurality of second inserts in the second supporting board corresponding to the third combination area and the fourth combination area are inserted into slots to extend the second cat scratching board and keep the second cat scratching board and the third cat scratching board in an upright position. Adhesives or twin adhesives on the side wall of the second supporting board are separately attached to the side wall of the third combination area and the side wall of the fourth combination area to extend the second cat scratching board and keep the second cat scratching and the third cat scratching in an upright position.

The main contributions of this invention are summarized as follows:
1. In this invention, it is to combine several cat scratching boards for the house cats to claw without being moved which increases the chances for the house cats to use them. What's more, the scratcher in the invention can be folded and unfolded which saves a great amount of space for storing goods. For the consumers or the manufacturers, the invention takes the advantage of small volume after folding, which is easy to carry and can save the transportation expenses and lower the cost.
2. In this invention, the first, second and third shells are to collect the scraps of paper and old nails after the house cats' clawing. When each clawing portion is out of use, it is convenient compared to conventional structure to fold and recycle the first, second and third cat scratching board directly.
3. In this invention, it has various ways for house cats to claw. The first, second and third scratching board assembled just as a jumping platform which attracts house cats' attention to prevent them from damaging the furniture, clothes or interior decoration in the house.

A detailed description is given in the following embodiments with reference to the accompanying drawings.

### BRIEF DESCRIPTION OF THE DRAWINGS

The components, characteristics and advantages of the present invention may be understood by the detailed descriptions of the preferred embodiments outlined in the specification and the drawings attached. Embodiments of the invention are illustrated by way of example, and not by way of limitation, in the figures of the accompanying drawings in which like reference numerals refer to similar elements.

FIG. 1 is a perspective structure view according to the first embodiment of the invention.

FIG. 2 is a folded-state view according to the first embodiment of the invention.

FIG. 3 is a perspective structure view according to the second embodiment of the invention.

FIG. 4 is a folded-state view according to the second embodiment of the invention.

FIG. 5 is a perspective structure view according to the third embodiment of the invention.

FIG. 6 is a perspective structure view according to the fourth embodiment of the invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

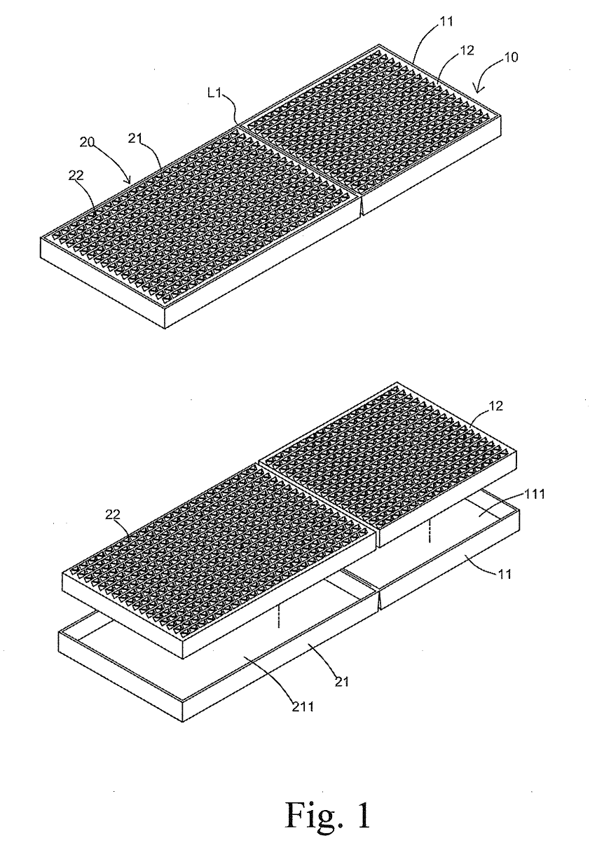

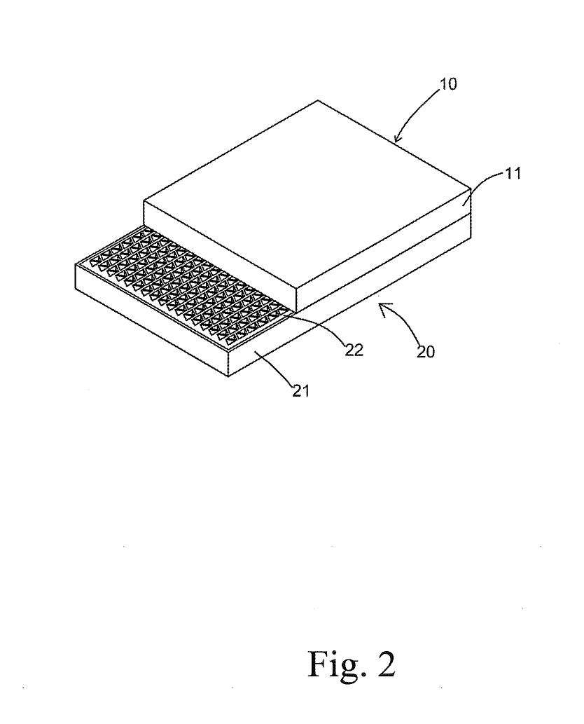

FIG. 1 is a perspective structure view according to the first embodiment of the invention. FIG. 2 is a folded-state view according to the first embodiment of the invention. Referring to FIG. 1 and FIG. 2, in the first embodiment, an environmentally friendly house cat scratcher with simple folding and assembling mainly includes a first cat scratching board 10 and a second cat scratching board 20.

Referring to FIG. 1 and FIG. 2, in the first embodiment, the first cat scratching board 10 has a first shell 11 and a first clawing portion 12. The first shell 11 has a trough 111, and the first clawing portion 12 has the clawing surface structure produced by die cutting after paper compression. Holes are provided on the clawing surface structures for clawing by house cats, and the first clawing portion 12 is assembled in the trough 111 of the first shell 11. For example, the first clawing portion 12 has the holes mainly produced by die cutting after corrugated paper compression for clawing. House cats will feel relaxed when clawing on the first clawing portion 12.

Referring to FIG. 1 and FIG. 2, in the first embodiment, the second cat scratching board 20 has a second shell 21 and a second clawing portion 22. The second shell 21 has a trough 211. The second clawing portion 22 has the clawing surface structure produced by die cutting after paper compression. Holes are provided on the clawing surface structures for clawing by house cats, and the second clawing portion 22 is assembled in the trough 211 of the second shell 21. In this embodiment, the length of the second cat scratching board 20 is slightly longer than the first cat scratching board 10. That is because house cats enjoy lying on the scratcher for clawing. If the size of scratcher is too small or the scratcher is easy to slide or move during clawing, house cats are not willing to claw on the scratcher. The other advantage of this invention is that the scratcher can attract house cats' attention to prevent them from damaging the furniture, clothes or interior decoration in the house.

Referring to FIG. 1 and FIG. 2, in the first embodiment, a first junction L1 is configured between the first shell 11 and the second shell 21. The first cat scratching board 10 is rotated corresponding to the second cat scratching board 20 via the first junction L1, enabling said first and second cat scratching boards to be folded or unfolded. In some embodiments, the first clawing portion 12 and the first shell 11 are combined through sticking cases such as adhesives or twin adhesives (not shown in Fig.); the second clawing portion 22 is connected to the trough 211 of second shell 21 via adhesives or twin adhesives. Based on this structure, it is convenient to use because the first clawing portion 12 cannot be detached from the first shell 11.

Referring to FIG. 1 and FIG. 2, the scratcher in the invention can be folded or unfolded for saving an amount of space. With folded scratcher, more goods can store in cargo to greatly save transportation expense when exporting. On the one hand, folded scratcher may save a great amount of space for superstores, on the other hand, the scratcher is easy to carry and assemble for customers. One can throw away the damaged first and second cat scratching boards 10, 20 easily after folding them, and the first shell 11 and the second shell 12 can be a dust collection structure facilitating environment cleaning.

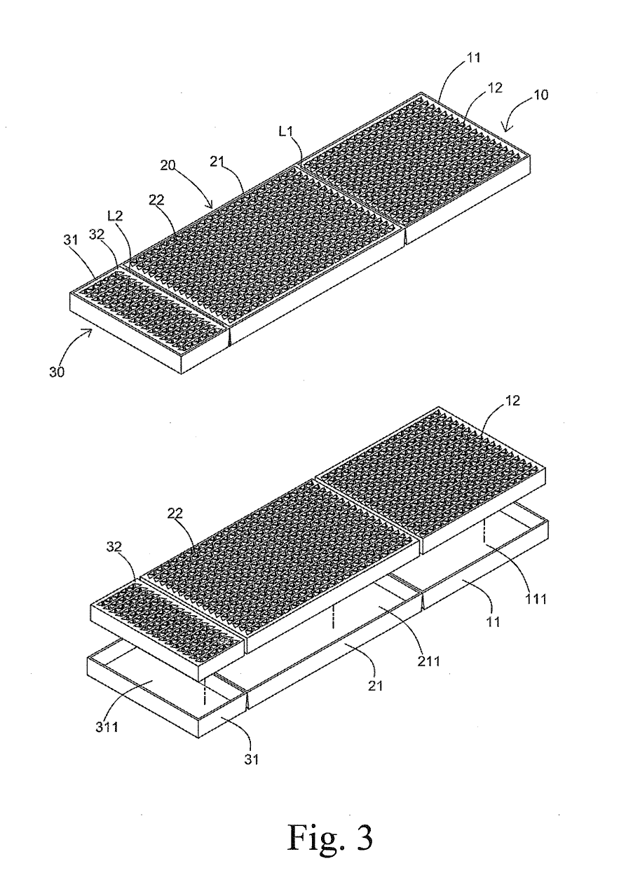

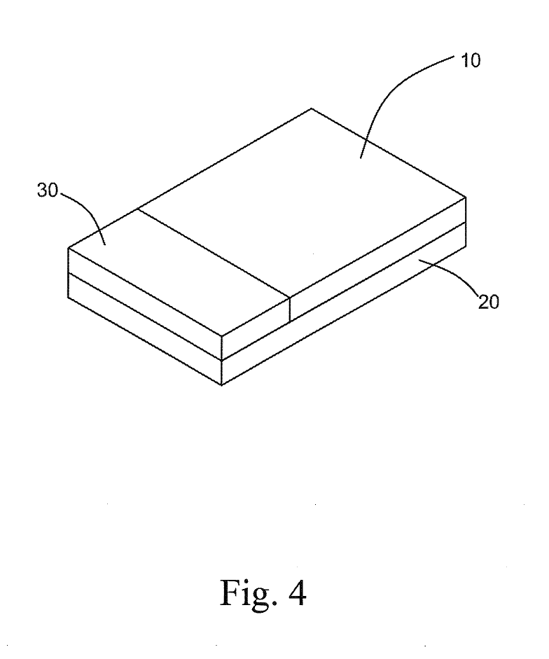

FIG. 3 is a perspective structure view according to the second embodiment of the invention. FIG. 4 is a folded-state view according to the second embodiment of the invention. Referring to FIG. 3 and FIG. 4, in the second embodiment, some people are not feeding only one cat in house, so the structure for several cats is provided. A third cat scratching board 30 is connected to the second cat scratching board 20. The third cat scratching board 30 has a third shell 31 and a third clawing portion 32, and the third shell 31 has a trough 311. The third clawing portion 32 has the clawing surface structures produced by die cutting after paper compression. Holes are provided on the clawing surface structures for clawing by house cats. The third clawing portion 32 is assembled in the trough 311 of the third shell 31. A second junction L2 is configured between the second shell 20 and the third shell 30, and the third cat scratching board 30 is rotated via the second junction L2, enabling the first 10, second 20, and third 30 cat scratching boards to be folded or unfolded. The third clawing portion 32 of third cat scratching board 30 is connected to the trough 311 of third shell 31 via adhesives or twin adhesives. Based on this embodiment, house cats playing or clawing on the first 10, second 20, and third 30 cat scratching boards can be provided. In addition, an example can be embodied as follows. There are several inserts (not shown in Fig.) in the first 12, second 22, and third clawing portion 32, and several inserting holes (not shown in Fig.) in the trough 111, 211, 311 of the first 11, second 21 third shell 31. Inserts of the first 12, second 22, and third clawing portion 32 are inserted into the trough 111, 211, 311 of the first 11, second 21 third shell 31.

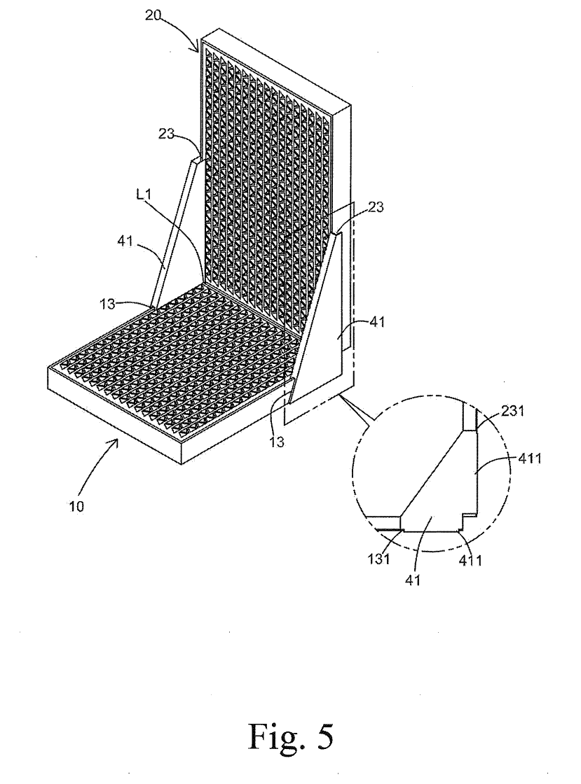

FIG. 5 is a perspective structure view according to the third embodiment of the invention. Referring to FIG. 5, in the third embodiment, the extension of the first embodiment, the first cat scratching board 10 has a first combination area 13 configured at two ends of the first junction. The second cat scratching board 20 has a second combination area 23 configured at two ends of the first junction. A plurality of first supporting boards 41 are assembled in two sides of the first combination area 13 and the second combination area 23, and the first supporting boards 41 are triangle boards to keep the first cat scratching board perpendicular to the second cat scratching board. The sticking cases such as adhesives or twin adhesives on the side wall of the first supporting boards 41 are separately attached to the side wall of the first combination area 13 and the side wall of the second combination area 23 to keep the first cat scratching board 10 perpendicular to the second cat scratching board 20. Based on third embodiment, not only house cats can lie down for clawing on the first cat scratching board 10, but also lie prone on the second cat scratching board 20 for clawing. Therefore, house cats' are attracted to scratch on the scratcher in the invention because of variability of clawing.

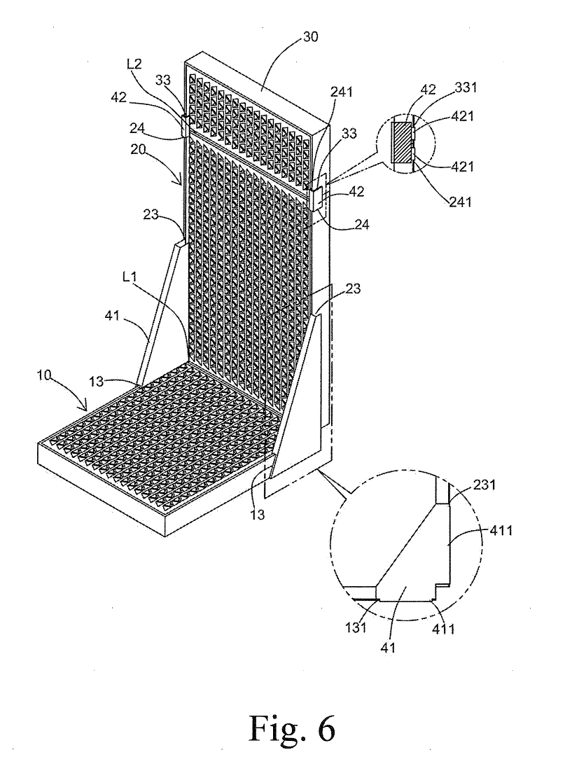

FIG. 6 is a perspective structure view according to the fourth embodiment of the invention. Referring to FIG. 6, in the fourth embodiment, the first cat scratching board 10 has a first combination area 13 configured at two ends of the first junction L1. The second cat scratching board 20 has a second combination area 23 configured at two ends of the first junction L1. A plurality of first supporting boards 41 are assembled in two side of the first combination area 13 and the second combination area 23, and the first supporting boards 41 are triangle boards to keep the first cat scratching board 10 perpendicular to the second cat scratching board 20; the second cat scratching board 20 has a third combination area 24 configured at two ends of the second junction L2. The third cat scratching board 30 has a fourth combination area 33 configured at two sides of the second junction L2. A plurality of second supporting boards 42 are assembled in two sides of the third combination area 24 and the fourth combination area 33, and the second supporting boards 42 are rectangle boards to extend the second cat scratching board 20 and keep the second cat scratching board 20 and the third cat scratching board 30 in an upright position. House cats are likely to stand high, so this embodiment can be used to attract cat's attention. As a result, house cats playing and scratching on this scratcher that prevents them from damaging furniture and clothes. Slots 241 are separately configured in the third combination area 24 and the fourth combination area 33, and a plurality of second inserts 421 in the second supporting boards 42 corresponding to the third combination area 24 and the fourth combination area 33 are inserted into slots 241, 331 to extend the second cat scratching board 20 and keep the second cat scratching board 20 and the third cat scratching board 30 in an upright position. In this embodiment, adhesives or twin adhesives on the side wall of the second supporting board 42 can be separately attached to the side wall of the third combination area 24 and the side wall of the fourth combination area 33 to extend the second cat scratching board 20 and keep the second cat scratching 20 and the third cat scratching board 30 in an upright position. In the fourth embodiment, the scratcher can be arranged on the side wall or some areas attracting cat by breeder. House cats are likely to stand high, so the structure just as a jumping platform can be used to attract house cats' attention. As a result, house cats playing and scratching on this scratcher that prevent them from damaging furniture and clothes. Also, cats will feel relax when clawing on this scratcher.

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the embodiments of the present invention is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists, in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example of the present invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the present invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

As will be understood by persons skilled in the art, the foregoing preferred embodiment of the present invention illustrates the present invention rather than limiting the present invention. Having described the invention in connection with a preferred embodiment, modifications will be suggested to those skilled in the art. Thus, the invention is not to be limited to this embodiment, but rather the invention is intended to cover various modifications and similar arrangements included within the spirit and scope of the appended claims, the scope of which should be accorded the broadest interpretation, thereby encompassing all such modifications and similar structures. While the preferred embodiment of the invention has been illustrated and described, it will be appreciated that various changes can be made without departing from the spirit and scope of the invention.

What is claimed is:

1. An environmentally friendly house cat scratcher with simple folding and assembling, mainly comprising a first cat scratching board and a second cat scratching board;
wherein said first cat scratching board has a first shell and a first clawing portion, said first shell has a trough, said first clawing portion has the clawing surface structure produced by die cutting after paper compression, holes are provided on said clawing surface structures for clawing by house cats, and said first clawing portion is assembled in said trough of said first shell;
wherein said second cat scratching board has a second shell and a second clawing portion, said second shell having a trough, said second clawing portion having the clawing surface structure produced by die cutting after paper compression, holes provided on said clawing surface structures for clawing by house cats, and said second clawing portion assembled in said trough of said second shell; and
wherein a first junction is configured between said first shell and said second shell, and said first cat scratching board rotated corresponding to said second cat scratching board via said first junction, enabling said first and second cat scratching boards to be folded or unfolded.

2. The environmentally friendly house cat scratcher of claim 1, further comprising a third cat scratching board connected to said second cat scratching board; wherein said third cat scratching board has a third shell and a third clawing portion, said third shell having a trough, said third clawing portion having the clawing surface structures produced by die cutting after paper compression, holes provided on said clawing surface structures for clawing by house cats, said third clawing portion assembled in said trough of said third shell, a second junction configured between said second shell and said third shell, and said third cat scratching board rotated via said second junction, enabling said first, second, and third cat scratching boards to be folded or unfolded.

3. The environmentally friendly house cat scratcher of claim 1, wherein said first cat scratching board has a first combination area configured at two ends of said first junction, said second cat scratching board having a second combination area configured at two ends of said first junction, a plurality of first supporting boards assembled in two sides of said first combination area and said second combination area, and said plurality of first supporting boards being triangle boards to keep said first cat scratching board perpendicular to said second cat scratching board.

4. The environmentally friendly house cat scratcher of claim 3, wherein a slot is configured in said first combination area and said second combination area, and a plurality of first inserts in said first supporting board inserted into said slot to keep said first cat scratching board perpendicular to said second cat scratching board.

5. The environmentally friendly house cat scratcher of claim 3, wherein the sticking cases on the side wall of said first supporting board are separately attached to the side wall of said first combination area and the side wall of said second combination area to keep said first cat scratching board perpendicular to said second cat scratching board.

6. The environmentally friendly house cat scratcher of claim 2, wherein said first cat scratching board has a first combination area configured at two ends of said first junction, said second cat scratching board having a second combination area configured at two ends of said first junction, a plurality of first supporting boards assembled in two sides of said first combination area and said second combination area, and said plurality of first supporting boards being triangle boards to keep said first cat scratching board perpendicular to said second cat scratching board; and
wherein said second cat scratching board has a third combination area configured at two ends of said second junction, said third cat scratching board having a fourth combination area configured at two sides of said second junction, a plurality of second supporting boards assembled in two sides of said third combination area and said fourth combination area, and said plurality of second supporting boards being rectangle boards to extend said second cat scratching board and keep said second cat scratching board and said third cat scratching board in an upright position.

7. The environmentally friendly house cat scratcher of claim 6, wherein a slot is configured in said third combination area and said fourth combination area, and a plurality of second inserts in said second supporting board corresponding to said third combination area and said fourth combination area inserted into said slot to extend said second cat scratching board and keep said second cat scratching board and said third cat scratching board in an upright position.

8. The environmentally friendly house cat scratcher of claim 7, wherein the sticking cases on the side wall of said second supporting boar are separately attached to the side wall of said second combination area and the side wall of said fourth combination area to extend said second cat scratching board and keep said second cat scratching board and said third cat scratching board in an upright position.

9. The environmentally friendly house cat scratcher of claim 2, wherein via sticking cases said first, second, and third clawing portion are attached to said slot of said first, second, and third shell.

10. The environmentally friendly house cat scratcher of claim 2, wherein said first, second, and third clawing portion have a plurality of inserts inserted into inserting holes configured in said plurality of troughs of first, second, and third shell.
